(19) United States
(12) Patent Application Publication
(10) Pub. No.: US 2024/0327227 A1
(43) Pub. Date: Oct. 3, 2024

(54) TWO-DIMENSIONAL PARTICLE, CONDUCTIVE FILM, CONDUCTIVE PASTE, AND COMPOSITE MATERIAL

(71) Applicant: Murata Manufacturing Co., Ltd., Nagaokakyo-shi (JP)

(72) Inventors: Akimaro YANAGIMACHI, Nagaokakyo-shi (JP); Masanori ABE, Nagaokakyo-shi (JP); Naoki ICHIJO, Nagaokakyo-shi (JP)

(21) Appl. No.: 18/739,780

(22) Filed: Jun. 11, 2024

Related U.S. Application Data
(63) Continuation of application No. PCT/JP2022/044947, filed on Dec. 6, 2022.

(30) Foreign Application Priority Data
Dec. 16, 2021 (JP) 2021-204423

(51) Int. Cl. C01B 32/921

(52) U.S. Cl. CPC C01B 32/921; C01P 2002/08; C01P 2002/20; C01P 2002/86; C01P 2004/20; C01P 2006/40

(57) ABSTRACT

A two-dimensional particle that includes: one or plural layers, wherein the one or plural layers include a layer body represented by: MₘXₙ, wherein M is at least one metal of Group 3, 4, 5, 6, or 7, X is a carbon atom, a nitrogen atom, or a combination thereof, n is 1 to 4, and m is more than n but not more than 5, and a modifier or terminal T exists on a surface of the layer body; and a Li atom, wherein the Li atom includes a first component and a second component in which a chemical shift measured by ⁷Li NMR is larger than that of the first component, and wherein a proportion of the first component in a total of the first component and the second component is not less than 17% by atom and not more than 70% by atom.

### CROSS REFERENCE TO RELATED APPLICATIONS

The present application is a continuation of International application No. PCT/JP2022/044947, filed Dec. 6, 2022, which claims priority to Japanese Patent Application No. 2021-204423, filed Dec. 16, 2021, the entire contents of each of which are incorporated herein by reference.

### TECHNICAL FIELD

The present disclosure relates to a two-dimensional particle, a conductive film, a conductive paste, and a composite material.

### BACKGROUND ART

In recent years, MXene has been attracting attention as a new material having conductivity. MXene is a type of so-called two-dimensional material, and as will be described later, is a layered material in the form of one or plural layers. In general, MXene is in the form of particles (which can include powders, flakes, nanosheets, and the like) of such a layered material.

Currently, various studies are being conducted toward the application of MXene to various electrical devices. For the above application, it is required to further enhance the conductivity and moisture resistance of a material containing MXene. As a part of the study, a washing treatment method of MXene has been studied.
Non-Patent Document 1 discloses that Li⁺ can be removed by washing MXene in the presence of an acid.
Non-Patent Document 1: Hongwu Chen, et al., “Pristine Titanium Carbide MXene Films with Environmentally Stable Conductivity and Superior Mechanical Strength” Adv. Mater. 2020, 30, 1906996

### SUMMARY OF THE DISCLOSURE

In MXene described in Non-Patent Document 1, Li⁺ is removed, but the conductivity decreases by about 20% due to moisture absorption. In addition, in the MXene described in Non-Patent Document 1, the conductivity of the film is not sufficiently satisfactory.

An object of the present disclosure is to provide a two-dimensional particle capable of realizing a conductive film having high conductivity and moisture resistance. In addition, an object of the present disclosure is to provide a conductive film, a conductive paste, and a conductive composite material using such two-dimensional particles.

The present disclosure provides the following embodiments.

<1> A two-dimensional particle comprising:
one or plural layers, wherein the one or plural layers include a layer body represented by:

MₘXₙ
wherein M is at least one metal of Group 3, 4, 5, 6, or 7,
X is a carbon atom, a nitrogen atom, or a combination thereof,
n is not less than 1 and not more than 4, and
m is more than n but not more than 5, and
a modifier or terminal T existing on a surface of the layer body, wherein T is at least one selected from the group consisting of a hydroxyl group, a fluorine atom, a chlorine atom, an oxygen atom, and a hydrogen atom,
a Li atom, wherein the Li atom includes a first component and a second component, wherein the second component has a second chemical shift measured by ⁷Li NMR that is larger than a first chemical shift of the first component, and wherein a proportion of the first component in a total of the first component and the second component is not less than 17% by atom and not more than 70% by atom.

<2> The two-dimensional particle according to <1>, wherein the first chemical shift of the first component measured by ⁷Li NMR is less than 0.6 ppm, and the second chemical shift of the second component measured by ⁷Li NMR is not less than 0.6 ppm and not more than 2.0 ppm.

<3> The two-dimensional particle according to <1> or <2>, further comprising a phosphorus atom.

<4> The two-dimensional particle according to any one of <1> to <3>, wherein a content of the phosphorus atom is not less than 0.1% by mass and not more than 14% by mass.

<5> The two-dimensional particle according to any one of <1> to <4>, wherein the phosphorus atom is in a form of PO₄³⁻.

<6> The two-dimensional particle according to any one of <1> to <5>, wherein an average thickness of the two-dimensional particle is not less than 1 nm and not more than 10 nm.

<7> A conductive film comprising the two-dimensional particle according to any one of <1> to <6>.

<8> A conductive paste comprising the two-dimensional particle according to any one of <1> to <6>.

<9> A conductive composite material comprising: the two-dimensional particle according to any one of <1> to <6>; and a resin.

The present disclosure provides a two-dimensional particle capable of realizing a conductive film having high conductivity and moisture resistance. In addition, the present disclosure provides a conductive film, a conductive paste, and a conductive composite material using such two-dimensional particles.

### BRIEF DESCRIPTION OF THE DRAWINGS

FIGS. 1(a) and 1(b) are schematic cross-sectional views illustrating MXene particles of a layered material in one embodiment of the present disclosure, in which FIG. 1(a) illustrates single-layer MXene particles, and FIG. 1(b) illustrates multilayer (exemplarily two-layer) MXene particles.

FIG. 2 is a schematic cross-sectional view illustrating a conductive film in one embodiment of the present disclosure.

### DETAILED DESCRIPTION

### First Embodiment: Two-Dimensional Particle

Hereinafter, a two-dimensional particle in one embodiment of the present disclosure will be described in detail, but the present disclosure is not limited to such an embodiment.

The two-dimensional particle in the present embodiment is a two-dimensional particle of a layered material including one or plural layers, and a Li atom.

The one or plural layers include a layer body (the layer body may have a crystal lattice in which each X is located in an octahedral array of M) represented by a formula below:

MₘXₙ
wherein M is at least one metal of Group 3, 4, 5, 6, or 7,
X is a carbon atom, a nitrogen atom, or a combination thereof,
n is not less than 1 and not more than 4, and
m is more than n but not more than 5, and
a modifier or terminal T existing on a surface (more particularly, at least one of the two opposing surfaces of the layer body) of the layer body, wherein T is at least one selected from the group consisting of a hydroxyl group, a fluorine atom, a chlorine atom, an oxygen atom, and a hydrogen atom,
wherein the Li atom includes a first component and a second component in which a chemical shift measured by ⁷Li NMR (nuclear magnetic resonance) is larger than that of the first component, and
wherein a proportion of the first component in a total of the first component and the second component is not less than 17% by atom and not more than 70% by atom.

Thus, the conductive film obtained using the two-dimensional particle of the present disclosure has high conductivity and good moisture resistance. In the present disclosure, the moisture resistance means that the conductivity can be maintained even when the substrate is placed under a high humidity condition for a long time. Furthermore, the electrode including such a conductive film can be used for applications requiring high conductivity and high moisture resistance, for example, as an antenna electrode, in particular, as an electrode for a radio frequency identifier (RFID).

In the present disclosure, when an element is referred to as an “atom”, the oxidation number of the element is not limited to zero, and may be any number within the range of possible oxidation numbers of the element.

The layered material can be understood as a layered compound and is also denoted by “MₘXₙTₛ”, in which s is an optional number, and in the related art, x or z may be used instead of s. Typically, n can be 1, 2, 3, or 4, but is not limited thereto.

In the above formula of MXene, M is preferably at least one selected from the group consisting of Ti, Zr, Hf, V, Nb, Ta, Cr, Mo, and Mn, and more preferably at least one selected from the group consisting of Ti, V, Cr, and Mo.

MXenes whose above formula MₘXₙ is expressed as below are known:
Sc₂C, Ti₂C, Ti₂N, Zr₂C, Zr₂N, Hf₂C, Hf₂N, V₂C, V₂N, Nb₂C, Ta₂C, Cr₂C, Cr₂N, Mo₂C, Mo_{1.3}C, Cr_{1.3}C, (Ti,V)₂C, (Ti,Nb)₂C, W₂C, W_{1.3}C, Mo₂N, Nb_{1.3}C, Mo_{1.3}Y_{0.6}C (In the above formula, “1.3” and “0.6” mean about 1.3 (=4/3) and about 0.6 (=2/3), respectively),
Ti₃C₂, Ti₃N₂, Ti₃(CN), Zr₃C₂, (Ti,V)₃C₂, (Ti₂Nb)C₂, (Ti₂Ta)C₂, (Ti₂Mn)C₂, Hf₃C₂, (Hf₂V)C₂, (Hf₂Mn)C₂, (V₂Ti)C₂, (Cr₂Ti)C₂, (Cr₂V)C₂, (Cr₂Nb)C₂, (Cr₂Ta)C₂, (Mo₂Sc)C₂, (Mo₂Ti)C₂, (Mo₂Zr)C₂, (Mo₂Hf)C₂, (Mo₂V)C₂, (Mo₂Nb)C₂, (Mo₂Ta)C₂, (W₂Ti)C₂, (W₂Zr)C₂, (W₂Hf)C₂,
Ti₄N₃, V₄C₃, Nb₄C₃, Ta₄C₃, (Ti,Nb)₄C₃, (Nb,Zr)₄C₃, (Ti₂Nb₂)C₃, (Ti₂Ta₂)C₃, (V₂Ti₂)C₃, (V₂Nb₂)C₃, (V₂Ta₂)C₃, (Nb₂Ta₂)C₃, (Cr₂Ti₂)C₃, (Cr₂V₂)C₃, (Cr₂Nb₂)C₃, (Cr₂Ta₂)C₃, (Mo₂Ti₂)C₃, (Mo₂Zr₂)C₃, (Mo₂Hf₂)C₃, (Mo₂V₂)C₃, (Mo₂Nb₂)C₃, (Mo₂Ta₂)C₃, (W₂Ti₂)C₃, (W₂Zr₂)C₃, (W₂Hf₂)C₃, (Mo_{2.7}V_{1.3})C₃ (In the above formula, “2.7” and “1.3” mean about 2.7 (=8/3) and about 1.3 (=4/3), respectively),
Typically in the above formula, M can be titanium or vanadium and X can be a carbon atom or a nitrogen atom. For example, the MAX phase is Ti₃AlC₂ and MXene is Ti₃C₂Tₛ (in other words, M is Ti, X is C, n is 2, and m is 3).

It is noted, in the present disclosure, MXene may contain remaining A atoms derived from the MAX phase of the precursor, at a relatively small amount, for example, at 10% by mass or less with respect to the original amount of A atoms. The remaining amount of A atoms can be preferably 8% by mass or less, and more preferably 6% by mass or less. However, even if the remaining amount of A atoms exceeds 10% by mass, there may be no problem depending on the application and use conditions of the two-dimensional particle.

In the present disclosure, the layer may be referred to as an MXene layer, and the two-dimensional particle may be referred to as an MXene two-dimensional particle or an MXene particle.

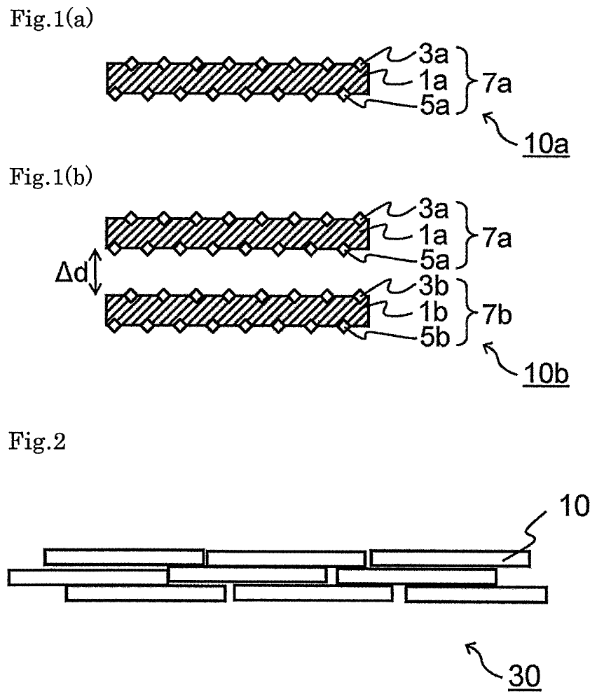

The two-dimensional particle of the present embodiment is an aggregate containing MXene particles (hereinafter, simply referred to as “MXene particles”) 10a (single-layer MXene particles) of one layer schematically exemplified in FIG. 1(a). More specifically, the MXene particle 10a is an MXene layer 7a having layer body (MmXI layer) la represented by MₘXₙ, and modifier or terminals T 3a and 5a existing on the surface (more specifically, at least one of two surfaces facing each other in each layer) of the layer body 1a. Therefore, the MXene layer 7a is also represented as “MₘXₙTₛ”, and s is an optional number.

The two-dimensional particle of the present embodiment may include one or plural layers. Examples of the MXene particles (multilayer MXene particles) of the plural layers include, but are not limited to, two layers of MXene particles 10b as schematically illustrated in FIG. 1(b). 1b, 3b, 5b, and 7b in FIG. 1(b) are the same as 1a, 3a, 5a, and 7a in FIG. 1(a) described above. Two adjacent MXene layers (for example, 7a and 7b) of the multilayer MXene particles do not necessarily have to be completely separated from each other, and may be partially in contact with each other. The MXene particles 10a may be a mixture of the single-layer MXene particles 10a and the multilayer MXene particles 10b, in which the multilayer MXene particles 10b is individually separated and exists as one layer and the unseparated multilayer MXene particles 10b remains.

Although the present embodiment is not limited, the thickness of each layer included in the MXene particles (which correspond to the MXene layers 7a and 7b) is, for example, not less than 0.8 nm and not more than 5 nm, particularly not less than 0.8 nm and not more than 3 nm (which may mainly vary depending on the number of M atom layers included in each layer). For the individual laminates of the multilayer MXene particles that can be included, the interlayer distance (or a void dimension indicated by Ad in FIG. 1(b)) is, for example, not less than 0.8 nm and not more than 10 nm, particularly not less than 0.8 nm and not more than 5 nm, and more particularly about 1 nm, and the total number of layers can be not less than 2 and not more than 20,000.

In the two-dimensional particle of the present embodiment, the multilayer MXene particles that can be contained are preferably MXene particles having a few layers obtained through a delamination treatment. The term “having a few layers” means that, for example, the number of stacked layers of MXene layers is six or less. The thickness, in the stacking direction, of the multilayer MXene particles having a few layers is preferably 15 nm or less and further preferably 10 nm or less. Hereinafter, the “multilayer MXene particles having a few layers” may be referred to as a “few-layer MXene particles” in some cases. In addition, the single-layer MXene particles and the few-layer MXene particles may be collectively referred to as “single-layer/few-layer MXene particles” in some cases.

The two-dimensional particle of the present embodiment preferably contains a single-layer MXene particles and a few-layer MXene particles, that is, a single-layer/few-layer MXene particles. In the two-dimensional particle of the present embodiment, the ratio of the single-layer/few-layer MXene particles having a thickness of 15 nm or less is preferably 90 vol % or more, and more preferably 95 vol % or more.

The Li atom includes a first component and a second component in which a chemical shift measured by ⁷Li NMR is larger than that of the first component, and a proportion of the first component in a total of the first component and the second component is not less than 17% by atom and not more than 70% by atom. As a result, a conductive film having high conductivity and moisture resistance can be realized.

The proportion of the first component to the total of the first component and the second component can be measured by ⁷Li NMR. For example, in ⁷Li NMR spectrum, when the relative area of the peak attributed to the first component is S₁ and the relative area of the peak attributed to the second component is S₂, the proportion of the first component to the total of the first component and the second component can be calculated as S₁/(S₁+S₂). In one embodiment, the integrated delay time in ⁷Li NMR measurement is 4 seconds.

Without being bound by a specific theory, it is considered that the first component is bound by water and exists in a state with a low degree of freedom, and the second component is loosely adsorbed on the layer surface of the two-dimensional particle and exists in a state with a relatively high degree of freedom. It is considered that when the first component and the second component coexist at a specific abundance ratio, it is possible to prevent adsorption of moisture while achieving single-layer and a few-layer, and to exhibit high conductivity and high moisture resistance.

The degrees of freedom of the first component and the second component can be confirmed, for example, by comparing T2 relaxation times (spin-spin relaxation times). Without being bound by a particular theory, it is believed that the T2 relaxation time is related to the mobility of each component, and the shorter the T2 relaxation time, the stronger the interaction with the material. In one embodiment, the T2 relaxation time of the first component is shorter than the T2 relaxation time of the second component, for example, the T2 relaxation time of the first component is 0.6 ms or less, and the T2 relaxation time of the second component is 1.2 ms or more. From the comparison of the T2 relaxation times of the first component and the second component, it is considered that the first component interacts more strongly with the substance than the second component.

In one embodiment, the chemical shift of the first component as measured by ⁷Li NMR may be, for example, less than 0.6 ppm, further not less than −0.2 ppm and not more than 0.55 ppm, and particularly not less than −0.15 ppm and not more than 0.5 ppm. In addition, the chemical shift of the second component measured by ⁷Li NMR can be, for example, not less than 0.6 ppm and not more than 2.0 ppm, and further not less than 0.7 ppm and not more than 1.7 ppm. In one embodiment, the reference substance in ⁷Li NMR measurement is Li in a 1 mol/L LiCl aqueous solution.

In the present disclosure, the chemical shift of the first component measured by ⁷Li NMR represents a chemical shift value of a peak attributed to the first component in a ⁷Li NMR spectrum. Similarly, the chemical shift of the second component measured by ⁷Li NMR represents a chemical shift value of a peak attributed to the second component in a ⁷Li NMR spectrum. The chemical shift of the second component is larger than the chemical shift of the first component measured by ⁷Li NMR, and the peak attributed to the second component is located on the lower magnetic field side of ⁷Li NMR spectrum with respect to the peak attributed to the first component. In ⁷Li NMR, when a peak attributed to the first component and a peak attributed to the second component overlap each other, peak separation may be performed by regression with a Lorentz curve.

The Li atom is typically present on the layer body. That is, it may be in contact with the layer body, or may be present on the layer body via another element.

The content of Li atoms in the two-dimensional particles (for example, the total of the layer and the metal cation) may be, for example, not less than 0.1% by mass and not more than 20% by mass, further not less than 0.1% by mass and not more than 10% by mass, especially not less than 0.2% by mass and not more than 5% by mass, and particularly not less than 0.2% by mass and not more than 3% by mass.

The content of the Li atom can be measured by, for example, an inductively coupled plasma emission spectrometry (ICP-AES) method.

In one embodiment, the two-dimensional particle contains a phosphorus atom. By containing a phosphorus atom, it is considered that a Li atom of the second component is likely to exist, and high conductivity and high moisture resistance are likely to be exhibited. The content of the phosphorus atom may be, for example, not less than 0.1% by mass and not more than 14% by mass, further not less than 0.15% by mass and not more than 5% by mass, and particularly not less than 0.15% by mass and not more than 1% by mass.

The phosphorus atom is present, for example, in the form of an anion containing a phosphorus atom, and may be present, in particular in the form of PO₄³⁻. The anion containing a phosphorus atom may be bonded to M of the layer. Although not bound by a specific theory, it is considered that a Li atom loosely adsorbed to an anion containing a phosphorus atom corresponds to the second component.

In one embodiment, the ratio of (average value of major diameters of two-dimensional surfaces of two-dimensional particles)/(average value of thicknesses of two-dimensional particles) is 1.2 or more, preferably 1.5 or more, and more preferably 2 or more. The average value of the major diameters of the two-dimensional surfaces of the two-dimensional particles and the average value of the thicknesses of the two-dimensional particles may be obtained by a method to be described later.

### (Average Value of Major Diameters of Two-Dimensional Surfaces of Two-Dimensional Particles)

In the two-dimensional particle of the present embodiment, the average value of the major diameters of the two-dimensional surfaces is not less than 1 m and not more than m. Hereinafter, the average value of the major diameters of the two-dimensional surfaces may be referred to as “average flake size”.

The conductivity of the conductive film increases as the average flake size increases. Since the two-dimensional particle of the present embodiment has a large average flake size of 1.0 m or more, a film formed using the two-dimensional particle, for example, a film obtained by stacking the two-dimensional particles can achieve conductivity of 2,000 S/cm or more. The average value of the major diameters of the two-dimensional surfaces is preferably 1.5 m or more, and more preferably 2.5 m or more. When the delamination treatment of MXene is performed by subjecting MXene to an ultrasonic treatment, most of MXene is reduced in diameter to about several hundred nm in major diameter by the ultrasonic treatment, so that the film formed of the single-layer MXene delaminated by the ultrasonic treatment is considered to have low conductivity.

The average value of the major diameters of the two-dimensional surfaces is 20 m or less, preferably 15 m or less, and more preferably 10 m or less from the viewpoint of dispersibility in a dispersion.

As described in examples to be described later, the major diameter of the two-dimensional surface refers to a major diameter when each MXene particle is approximated to an elliptical shape in an electron micrograph, and the average value of the major diameters of the two-dimensional surface refers to a number average of the major diameters of 80 particles or more. As the electron microscope, a scanning electron microscope (SEM) photograph or a transmission electron microscope (TEM) photograph can be used.

The average value of the major diameters of the two-dimensional particles of the present embodiment may be measured by dissolving a conductive film including the two-dimensional particles in a solvent and dispersing the two-dimensional particles in the solvent. Alternatively, it may be measured from an SEM image of the conductive film.

### (Average Value of Thicknesses of Two-Dimensional Particles)

The average value of the thicknesses of the two-dimensional particles of the present embodiment is preferably not less than 1 nm and not more than 15 nm. The thickness is preferably 10 nm or less, more preferably 7 nm or less, and still more preferably 5 nm or less. On the other hand, in consideration of the thickness of the single-layer MXene particle, the lower limit of the thickness of the two-dimensional particle may be 1 nm.

The average value of the thicknesses of the two-dimensional particles is determined as a number average dimension (for example, a number average of at least 40 particles) based on an atomic force microscope (AFM) photograph or a transmission electron microscope (TEM) photograph.

### Second Embodiment: Method for Producing Two-Dimensional Particle

Hereinafter, a method for producing a two-dimensional particle in one embodiment of the present disclosure will be described in detail, but the present disclosure is not limited to such an embodiment.

A method for producing a two-dimensional particle of the present embodiment, the method including: (a) preparing a predetermined precursor; (b) removing at least a part of A atoms from the precursor by using an etching solution to obtain an etched product, the etching solution containing a phosphorus atom; (c) washing the etched product with water to obtain a water-washed product; (d) mixing the water-washed product with a metal-containing compound to obtain an intercalated product, the metal-containing compound containing at least a Li atom; and (e) performing a delamination treatment to obtain a two-dimensional particle, the delamination treatment including a step of stirring the intercalated product so as to delaminate the intercalated product and obtain a two-dimensional particle.

Hereinafter, each step will be described in detail.

### Step (a)

First, a predetermined precursor is prepared. A predetermined precursor that can be used in the present embodiment is a MAX phase that is a precursor of MXene, and is represented by a formula below:

MₘAXₙ
wherein M is at least one metal of Group 3, 4, 5, 6, or 7,
X is a carbon atom, a nitrogen atom, or a combination thereof,
A is at least one metal of Group 12, 13, 14, 15, or 16,
n is not less than 1 and not more than 4, and
m is more than n but not more than 5.

The above M, X, n, and m are as described in the first embodiment. A is at least one element of Group 12, 13, 14, 15, or 16, is usually a Group A element, typically Group IIIA and Group IVA, more specifically, may include at least one selected from the group consisting of Al, Ga, In, Tl, Si, Ge, Sn, Pb, P, As, S, and Cd, and is preferably Al.

The MAX phase has a crystal structure in which a layer constituted by A atoms is located between two layers represented by MₘXₙ (each X may have a crystal lattice located in an octahedral array of M). When typically m=n+1, but not limited thereto, the MAX phase includes repeating units in which each one layer of X atoms is disposed in between adjacent layers of n+1 layers of M atoms (these are also collectively referred to as an “MₘXₙ layer”), and a layer of A atoms (“A atom layer”) is disposed as a layer next to the (n+1)th layer of M atoms. The A atom layer (and optionally a part of the M atoms) is removed by selectively etching (removing and optionally layer-separating) the A atoms (and optionally a part of the M atoms) from the MAX phase.

The MAX phase can be produced by a known method. For example, a TiC powder, a Ti powder, and an Al powder are mixed in a ball mill, and the obtained mixed powder is calcined under an Ar atmosphere to obtain a calcined body (block-shaped MAX phase). Thereafter, the calcined body obtained is pulverized by an end mill to obtain a powdery MAX phase for the next step.

### Step (b)

In Step (b), an etching treatment is performed to remove at least a part of A atoms from the precursor using an etching solution.

The etching solution contains a phosphorus atom, and particularly contains an anion containing a phosphorus atom. With this, a phosphorus atom, for example a phosphorus atom, particularly an anion containing a phosphorus atom, may be attached to the M atom. In addition, although not bound by a specific theory, it is considered that since the etching solution contains a phosphorus atom, a Li atom of the second component is likely to exist. Furthermore, a sufficient etching treatment becomes possible, and the Li atom is easily intercalated in the subsequent intercalation treatment. The existence form of the anion containing a phosphorus atom is not particularly limited, and may exist as an ion, may exist as an acid by being bonded to H⁺, or may exist as a salt by being bonded to a cation.

Examples of the anion containing a phosphorus atom include PO₄³⁻.

The etching solution preferably contains H₃PO₄, and may further contain HF. Specific examples of the etching solution include a mixed solution of an aqueous solution of HF and an aqueous solution of H₃PO₄. The etching solution may further contain HCl and LiF.

In the etching solution, the concentration of the anion containing a phosphorus atom, particularly PO₄³⁻, may be, for example, not less than 2 mol/L and not more than 20 mol/L, further not less than 2.5 mol/L and not more than 18 mol/L, and particularly not less than 3 mol/L and not more than 15 mol/L.

In the etching solution, the concentration of HF can be, for example, not less than 2 mol/L and not more than 20 mol/L, further not less than 2.5 mol/L and not more than 18 mol/L, and particularly not less than 2.5 mol/L and not more than 15 mol/L.

In the etching solution, the total of the concentration of the anion containing a phosphorus atom and the concentration of HF may be, for example, not less than 7 mol/L and not more than 30 mol/L, further not less than 7.5 mol/L and not more than 27 mol/L, and particularly not less than 8 mol/L and not more than 25 mol/L.

As the etching operation using the etching solution and other conditions, conventionally performed conditions can be adopted.

### Step (c)

The etched product obtained by the etching treatment is washed with water. By performing water washing, the acid and the like used in the etching treatment can be sufficiently removed. The amount of water mixed with the etched product and the washing method are not particularly limited. For example, stirring, centrifugation, and the like may be performed by adding water. Examples of the stirring method include stirring using a handshake, an automatic shaker, a share mixer, a pot mill, or the like. The degree of stirring such as stirring speed and stirring time may be adjusted according to the amount, concentration, and the like of the acid-treated product which is an object to be treated. The washing with water may be performed one or more times. Preferably, washing with water is performed plural times. For example, specifically, steps (i) adding water and stirring (to the etched product or the remaining precipitate obtained in the following (iii)), (ii) centrifuging the stirred product, and (iii) discarding a supernatant after centrifugation are performed 2 times or more, for example, 15 times or less.

### Step (d)

An intercalation treatment including a step of mixing the water-washed product obtained by the water washing with a metal-containing compound containing metal ion is performed. As a result, the metal ion is intercalated between the layers.

Examples of the metal ion include monovalent metal ions, and specifically include alkali metal ions such as a lithium ion, a sodium ion, and a potassium ion, a copper ion, a silver ion, and a gold ion. Examples of the metal-containing compound containing a metal ion include an iodide, a sulfide salt containing a phosphate and a sulfate of the metal ion, a nitrate, an acetate, and a carboxylate.

The metal ion includes at least a lithium ion. In addition, the metal-containing compound preferably contains a metal compound containing a lithium ion, more preferably contains an ionic compound of a lithium ion, further preferably contains one or more of an iodide, a phosphate, and a sulfide salt of a lithium ion, and particularly preferably contains a phosphate of a lithium ion. By using a lithium ion as the metal ion, the obtained two-dimensional particle may contain a Li atom.

In the formulation for intercalation treatment when the water-washed product and the metal-containing compound are mixed, the content of the metal-containing compound may be, for example, not less than 0.001% by mass and not more than 10% by mass, further not less than 0.01% by mass and not more than 1% by mass, and particularly not less than 0.1% by mass and not more than 1% by mass. When the content of the metal-containing compound is within the above range, the dispersibility in the formulation for intercalation treatment is good.

A specific method of the intercalation treatment is not particularly limited, and for example, the metal-containing compound may be mixed with the water-washed product, and the mixture may be stirred or left to stand. For example, stirring at room temperature can be mentioned. Examples of the stirring method include a method using a stirring bar such as a stirrer, a method using a stirring blade, a method using a mixer, and a method using a centrifugal device, and the stirring time can be set according to the manufacturing scale of the single-layer/few-layer MXene particles, and for example, the stirring time can be set to 12 to 24 hours.

### Step (e)

In Step (e), a delamination treatment including a step of stirring the intercalated product obtained by performing the intercalation treatment is performed. By this delamination treatment, it is possible to realize the single-layer/few-layer MXene particles.

The conditions for delamination treatment are not particularly limited, and delamination can be performed by a known method. Examples of the stirring method include stirring using an ultrasonic treatment, a handshake, an automatic shaker, or the like. The degree of stirring such as stirring speed and stirring time may be adjusted according to the amount, concentration, and the like of the treated product which is an object to be treated. For example, the slurry after the intercalation is centrifuged to discard the supernatant, then pure water is added to the remaining precipitate, and stirring is performed by, for example, a handshake or an automatic shaker to perform layer separation. The removal of an unpeeled substance includes a step of performing centrifugal separation to discard the supernatant, and then washing the remaining precipitate with water. For example, (i) pure water is added to the remaining precipitate after discarding the supernatant and stirred, (ii) centrifugation is performed, and (iii) the supernatant is recovered. This operation of (i) to (iii) is repeated 1 time or more, preferably 2 times or more, and 10 times or less to obtain a supernatant containing a single-layer/few-layer MXene particle before the acid treatment as a delaminated product. Alternatively, the supernatant may be centrifuged, the supernatant after centrifugation may be discarded, and a clay containing a single-layer/few-layer MXene particle before the acid treatment may be obtained as a delaminated product.

In the production method of the present embodiment, a phosphorus atom may coexist during delamination. Such a phosphorus atom may be present in the form of an anion containing a phosphorus atom, or may be present in the form of PO₄³⁻. In this case, pure water to be added to the precipitate may be a phosphoric acid aqueous solution. The pH of the phosphoric acid aqueous solution may be, for example, 2 to 5 or 2.5 to 4.5.

In one embodiment, the phosphorus atoms may coexist only at the time of layer separation, and the phosphorus atoms may not coexist at the time of washing. For example, after the slurry after the intercalation is centrifuged and the supernatant is discarded, a phosphoric acid aqueous solution may be used instead of pure water to be added to the remaining precipitate, and pure water may be added in the operation (i). In another embodiment, phosphorus atoms may coexist during layer separation and washing. For example, after the slurry after the intercalation is centrifuged and the supernatant is discarded, a phosphoric acid aqueous solution may be used instead of pure water to be added to the remaining precipitate, and a phosphoric acid aqueous solution may be used instead of the pure water to be added by the operation of (i).

In the production method of the present embodiment, the ultrasonic treatment may not be performed at the time of the delamination treatment. When the ultrasonic treatment is not performed, particle breakage hardly occurs, and it is easy to obtain single-layer/few-layer MXene particles having a large plane parallel to the layer of particles, that is, a two-dimensional plane.

The delaminated product obtained by stirring can be used as two-dimensional particles containing single-layer/few-layer MXene particles as it is, and may be washed with water as necessary.

### Third Embodiment: Conductive Film

Examples of applications of the two-dimensional particles of the present embodiment include a conductive film containing two-dimensional particles. Such a conductive film has high conductivity, high moisture resistance, and high smoothness. Referring to FIG. 2, the conductive film of the present embodiment will be described. FIG. 2 illustrates a conductive film 30 obtained by stacking only the two-dimensional particles 10, but the present disclosure is not limited thereto. The conductive film may contain an additive such as a binder added at the time of film formation as necessary. The additive accounts for preferably 30 vol % or less, more preferably 10 vol % or less, still more preferably 5 vol % or less, and most preferably 0 vol % in terms of a proportion in the conductive film (when dried).

As a method for producing the conductive film without using the binder or the like, the conductive film can be produced by subjecting the supernatant containing the two-dimensional particles obtained by the delamination to suction filtration, or by performing a step of spraying the two-dimensional particles in a form of a slurry with an appropriate concentration mixed with a dispersion and then removing the dispersion by drying or the like once or plural times. The spraying method may be, for example, an airless spraying method or an air spraying method, and specific examples thereof include a method of spraying using a nozzle such as a one-fluid nozzle, a two-fluid nozzle, or an air brush. Examples of the dispersion that can be contained in the slurry include water; organic media such as N-methylpyrrolidone, N-methylformamide, N,N-dimethylformamide, methanol, ethanol, dimethylsulfoxide, ethylene glycol, and acetic acid.

Examples of the binder include an acrylic resin, a polyester resin, a polyamide resin, a polyolefin resin, a polycarbonate resin, a polyurethane resin, a polystyrene resin, a polyether resin, and polylactic acid.

The conductivity of the conductive film is preferably 2,000 S/cm or more, more preferably 5,000 S/m or more, still more preferably 10,000 S/cm or more, and may be, for example, 100,000 S/cm or less, still more preferably 50,000 S/cm or less.

The conductivity of the conductive film of the present embodiment is determined by substituting the thickness of the conductive film and the surface resistivity of the conductive film measured by a four-probe method into the following formula.

Conductivity [S/cm]=1/(thickness [cm] of conductive film×surface resistivity [Ω/sq.] of conductive film)

### Fourth Embodiment: Conductive Paste and Conductive Composite Material

Examples of other applications in which the two-dimensional particle of the present embodiment is used include a conductive paste containing the two-dimensional particle and a resin or additive (dispersion, viscosity modifier, and the like) to be used as necessary, and a conductive composite material containing the two-dimensional particle and the resin. These are also suitable for applications in which high conductivity is required to be maintained even under high humidity conditions.

Examples of the resin that can be contained in the conductive paste and the conductive composite material include the same resin as the resin that can be contained in the conductive film. Examples of the dispersion that can be contained in the conductive paste include water; organic media such as N-methylpyrrolidone, N-methylformamide, N,N-dimethylformamide, methanol, ethanol, dimethylsulfoxide, ethylene glycol, and acetic acid.

### Fifth Embodiment: Electrode

The electrode according to the present embodiment includes the conductive film. The electrode may be formed of only the conductive film, or may include the conductive film and, for example, a substrate.

The electrode of the present embodiment only needs to include the conductive film, and is not limited to a specific form. Examples of the electrode include an electrode in a solid state and an electrode in a flexible and soft state.

In the electrode of the present embodiment, the conductive film may be exposed to the outside air so as to be brought into direct contact with an object to be measured, or may be covered with the substrate or the like.

When the electrode of the present embodiment includes the substrate, the conductive film and the substrate may be brought into direct contact with each other. The material of the substrate is not particularly limited, and may be, for example, an inorganic material such as ceramic or glass, or an organic material. Examples of the organic material include flexible organic materials, and specifically include a thermoplastic polyurethane elastomer (TPU), a PET film, and a polyimide film. The material of the substrate may be a fiber material (for example, the sheet-shaped fiber material) such as paper or cloth.

### (Application of Electrode)

The electrode of the present embodiment can be used for any appropriate application. Examples thereof include a counter electrode and a reference electrode in electrochemical measurement, an electrochemical capacitor electrode, a battery electrode, a biological electrode, a sensor electrode, an antenna electrode, and the like. It may be used in applications where maintaining high conductivity (to reduce a decrease in initial conductivity and prevent oxidation) is required, such as electromagnetic shielding (EMI shielding). Details of these applications will be described below.

The electrode is not particularly limited, and may be, for example, a capacitor electrode, a battery electrode, a biosignal sensing electrode, a sensor electrode, an antenna electrode, or the like. By using the conductive film, it is possible to obtain a large-capacity capacitor and battery, a low-impedance biosignal sensing electrode, a highly sensitive sensor, and an antenna even with a smaller volume (device occupied volume).

The capacitor may be an electrochemical capacitor. The electrochemical capacitor is a capacitor using capacitance developed due to a physicochemical reaction between an electrode (electrode active material) and ions (electrolyte ions) in an electrolytic solution, and can be used as a device (power storage device) that stores electric energy. The battery may be a repeatedly chargeable and dischargeable chemical battery. The battery may be, for example, but not limited to, a lithium ion battery, a magnesium ion battery, a lithium sulfur battery, a sodium ion battery, or the like.

The biosignal sensing electrode is an electrode for acquiring a biological signal. The biosignal sensing electrode may be, for example, but not limited to, an electrode for measuring electroencephalogram (EEG), electrocardiogram (ECG), electromyogram (EMG), electrical impedance tomography (EIT).

The sensor electrode is an electrode for detecting a target substance, state, abnormality, or the like. The sensor may be, for example, but not limited to, a gas sensor, a biosensor (a chemical sensor utilizing a molecular recognition mechanism of biological origin), or the like.

The antenna electrode is an electrode for emitting an electromagnetic wave into a space and/or receiving an electromagnetic wave in the space. The antenna formed by the antenna electrode is not particularly limited, and examples thereof include mobile communication antennas (antenna for so-called 3G, 4G, and 5G) such as mobile phones, RFID antennas, and near field communication (NFC) antennas.

The electrode of the present embodiment is preferably used as an antenna electrode. The electrode including the conductive film has high conductivity and high moisture resistance, and has high smoothness as a conductive film. An electrode having such characteristics can be advantageously used for extending a communication distance.

Although the two-dimensional particle in one embodiment of the present disclosure has been described in detail above, various modifications are possible. It should be noted that the two-dimensional particle according to the present disclosure may be produced by a method different from the production method in the above-described embodiment, and the method for producing a two-dimensional particle of the present disclosure is not limited only to one that provides the two-dimensional particle according to the above-described embodiment.

### EXAMPLES

The present disclosure will be described more specifically with reference to the following examples, but the present disclosure is not limited thereto.

### Examples 1 to 8 and Comparative Examples 1 and 2

### [Production of Two-Dimensional Particles]

In Examples 1 to 8 and Comparative Examples 1 and 2, the two-dimensional particles were produced by sequentially performing the following steps described in detail below: (1) Preparation of precursor (MAX), (2) Etching of precursor, (3) Washing, (4) Intercalation, (5) Delamination, and (6) Water washing.

### (1) Preparation of Precursor (MAX)

TiC powder, Ti powder, and Al powder (all manufactured by Kojundo Chemical Laboratory Co., Ltd.) were placed in a ball mill containing zirconia balls at a molar ratio of 2:1:1 and mixed for 24 hours. The obtained mixed powder was calcined in an Ar atmosphere at 1,350° C. for 2 hours. The obtained calcined body (block) was crushed with an end mill to a maximum size of 40 m or less. In this way, Ti₃AlC₂ particles were obtained as a precursor (MAX).

### (2) Etching of Precursor

Using the Ti₃AlC₂ particles (powder) prepared by the above method, etching was performed under the following etching conditions to obtain a solid-liquid mixture (slurry) containing a solid component derived from the Ti₃AlC₂ powder.

### (Etching Conditions)

Precursor: Ti₃AlC₂ (sieving with a mesh size of 45 m)
Refer to Table 1 for Etching solution composition
Amount of precursor input: 3.0 g
Etching container: 100 mL bottle made of polypropylene (Aiboy)
Etching temperature: 35° C.
Etching time: 24 h
Stirrer rotation speed: 400 rpm

### (3) Washing

The slurry was divided into two portions, each of which was inserted into two 50 mL centrifuge tubes, centrifuged for 5 minutes under the condition of 3500 G using a centrifuge, and then the supernatant was discarded. An operation of adding 35 mL of pure water to each centrifuge tube, centrifuging again for 5 minutes at 3500 G, and separating and removing the supernatant was repeated 11 times. After final centrifugation, the supernatant was discarded to obtain a Ti₃C₂ Tₛ-moisture medium clay.

### (4) Intercalation

With respect to the Ti₃C₂Tₛ-moisture medium clay prepared by the above method, 5.3 g of a 85% by mass phosphoric acid aqueous solution, 0.68 g of Li₃PO₄, and 31.9 g of pure water were added, and the mixture was stirred at not lower than 20° C. and not higher than 25° C. for 24 hours to perform intercalation using lithium ions as an intercalator. The detailed conditions of intercalation are as follows.

### (Conditions of Intercalation)

Ti₃C₂ Tₛ-moisture medium clay (MXene after washing): Solid content 0.5 g
Metal-containing compound: 0.68 g of Li₃PO₄
Intercalation container: 100 mL bottle made of polypropylene (Aiboy)
Temperature: not lower than 20° C. and not higher than 25° C. (room temperature)
Time: 24 hours
Stirrer rotation speed: 700 rpm

### (5) Delamination

The slurry obtained by intercalation was charged into a 50 mL centrifuge tube, centrifuged for 5 minutes under the condition of 3,500 G using a centrifuge, and then the supernatant was recovered. Further, an operation of adding 35 mL of a phosphoric acid aqueous solution adjusted to pH3.5, then stirring the mixture with a shaker for 15 minutes, centrifuging the mixture for 5 minutes at 3,500 G, and recovering the supernatant as a single-layer MXene particle-containing liquid was repeated 4 times to obtain a single-layer MXene particle-containing supernatant. Further, this supernatant was centrifuged under the conditions of 4,300 G and 2 hours using a centrifuge, and then the supernatant was discarded to obtain a clay containing two-dimensional particles (single-layer MXene particles).

### Example 9

The preparation of the precursor (MAX), the etching step, the washing step, and the delamination step were performed in the same manner as in Example 1, and then the following step (5) was performed to produce a clay containing two-dimensional particles (single-layer MXene particles).
(1) Preparation of precursor (MAX): Same as in Examples 1 to 8
(2) Etching of precursor: Same as in Examples 1 to 8
(3) Washing: Same as in Example 1
(4) Intercalation: Same as in Examples 1 to 8
(5) Delamination

The slurry obtained by intercalation was charged into a 50 mL centrifuge tube, centrifuged for 5 minutes under the condition of 3,500 G using a centrifuge, and then the supernatant was obtained. Further, this supernatant was centrifuged under the conditions of 4,300 G and 2 hours using a centrifuge, and then the supernatant was discarded to obtain a clay containing two-dimensional particles (single-layer MXene particles).

### Example 10

The preparation of the precursor (MAX), the etching step, the washing step, and the delamination step were performed in the same manner as in Example 1, and then the following step (5) was performed to produce a clay containing two-dimensional particles (single-layer MXene particles).
(1) Preparation of precursor (MAX): Same as in Examples 1 to 8
(2) Etching of precursor: Same as in Examples 1 to 8
(3) Washing: Same as in Example 1
(4) Intercalation: Same as in Examples 1 to 8
(5) Delamination

The slurry obtained by intercalation was charged into a 50 mL centrifuge tube, centrifuged for 5 minutes under the condition of 3,500 G using a centrifuge, and then the supernatant was recovered to obtain a clay containing two-dimensional particles (single-layer MXene particles). Further, an operation of adding 35 mL of water, then stirring the mixture with a shaker for 15 minutes, centrifuging the mixture for 5 minutes at 3,500 G, and recovering the supernatant as a single-layer MXene particle-containing liquid was performed to obtain a single-layer MXene particle-containing supernatant. Further, this supernatant was centrifuged under the conditions of 4,300 G and 2 hours using a centrifuge, and then the supernatant was discarded to obtain a clay containing two-dimensional particles (single-layer MXene particles).

### Example 11

The preparation of the precursor (MAX), the etching step, the washing step, and the delamination step were performed in the same manner as in Example 1, and then the following step (5) was performed to produce a clay containing two-dimensional particles (single-layer MXene particles).
(1) Preparation of precursor (MAX): Same as in Examples 1 to 8
(2) Etching of precursor: Same as in Examples 1 to 8
(3) Washing: Same as in Example 1
(4) Intercalation: Same as in Examples 1 to 8
(5) Delamination

The slurry obtained by intercalation was charged into a 50 mL centrifuge tube, centrifuged for 5 minutes under the condition of 3,500 G using a centrifuge, and then the supernatant was recovered to obtain a clay containing two-dimensional particles (single-layer MXene particles). Further, an operation of adding 35 mL of water, then stirring the mixture with a shaker for 15 minutes, centrifuging the mixture for 5 minutes at 3,500 G, and recovering the supernatant as a single-layer MXene particle-containing liquid was repeated twice to obtain a single-layer MXene particle-containing supernatant. Further, this supernatant was centrifuged under the conditions of 4,300 G and 2 hours using a centrifuge, and then the supernatant was discarded to obtain a clay containing two-dimensional particles (single-layer MXene particles).

### Example 12

The preparation of the precursor (MAX), the etching step, the washing step, and the delamination step were performed in the same manner as in Example 1, and then the following step (5) was performed to produce a clay containing two-dimensional particles (single-layer MXene particles).
(1) Preparation of precursor (MAX): Same as in Examples 1 to 8
(2) Etching of precursor: Same as in Examples 1 to 8
(3) Washing: Same as in Example 1
(4) Intercalation: Same as in Examples 1 to 8
(5) Delamination

The slurry obtained by intercalation was charged into a 50 mL centrifuge tube, centrifuged for 5 minutes under the condition of 3,500 G using a centrifuge, and then the supernatant was recovered to obtain a clay containing two-dimensional particles (single-layer MXene particles). Further, an operation of adding 35 mL of water, then stirring the mixture with a shaker for 15 minutes, centrifuging the mixture for 5 minutes at 3,500 G, and recovering the supernatant as a single-layer MXene particle-containing liquid was repeated three times to obtain a single-layer MXene particle-containing supernatant. Further, this supernatant was centrifuged under the conditions of 4,300 G and 2 hours using a centrifuge, and then the supernatant was discarded to obtain a clay containing two-dimensional particles (single-layer MXene particles).

### Example 13

The preparation of the precursor (MAX), the etching step, the washing step, and the delamination step were performed in the same manner as in Example 1, and then the following step (5) was performed to produce a clay containing two-dimensional particles (single-layer MXene particles).
(1) Preparation of precursor (MAX): Same as in Examples 1 to 8
(2) Etching of precursor: Same as in Examples 1 to 8
(3) Washing: Same as in Example 1
(4) Intercalation: Same as in Examples 1 to 8
(5) Delamination

The slurry obtained by intercalation was charged into a 50 mL centrifuge tube, centrifuged for 5 minutes under the condition of 3,500 G using a centrifuge, and then the supernatant was recovered to obtain a clay containing two-dimensional particles (single-layer MXene particles). Further, an operation of adding 35 mL of water, then stirring the mixture with a shaker for 15 minutes, centrifuging the mixture for 5 minutes at 3,500 G, and recovering the supernatant as a single-layer MXene particle-containing liquid was repeated four times to obtain a single-layer MXene particle-containing supernatant. Further, this supernatant was centrifuged under the conditions of 4,300 G and 2 hours using a centrifuge, and then the supernatant was discarded to obtain a clay containing two-dimensional particles (single-layer MXene particles).

### Comparative Example 3

After the precursor (MAX) was prepared in the same manner as in Example 1, the following step (2) was performed, the washing step was performed in the same manner as in Example, and the following steps (4) and (5) were further performed to produce a clay containing two-dimensional particles (single-layer MXene particles).
(1) Preparation of precursor (MAX): Same as in Example 1
(2) Etching of precursor

Using the Ti₃AlC₂ particles (powder) prepared by step of (1), etching was performed under the following etching conditions to obtain a solid-liquid mixture (slurry) containing a solid component derived from the Ti₃AlC₂ powder.

### (Etching Conditions)

Precursor: Ti₃AlC₂ (sieving with a mesh size of 45 μm)
Etching solution composition: 6 mL of 49% HF,
   H₂O 18 mL
   HCl(12M) 36 mL
Amount of precursor input: 3.0 g
Etching container: 100 mL bottle made of polypropylene (Aiboy)
Etching temperature: 35° C.
Etching time: 24 h
Stirrer rotation speed: 400 rpm
(3) Washing: Same as in Example 1
(4) Intercalation

With respect to the Ti₃C₂Tₛ-moisture medium clay prepared by the above method, 0.75 g of LiCl, and 37.2 g of pure water were added, and the mixture was stirred at not lower than 20° C. and not higher than 25° C. for 24 hours to perform intercalation using lithium ions as an intercalator. The detailed conditions of intercalation are as follows.

### (Conditions of Intercalation)

Ti₃C₂Tₛ-moisture medium clay (MXene after washing): Solid content 0.5 g
Metal-containing compound: 0.75 g of LiCl
Intercalation container: 100 mL bottle made of polypropylene (Aiboy)
Temperature: not lower than 20° C. and not higher than 25° C. (room temperature)
Time: 24 hours
Stirrer rotation speed: 700 rpm
(5) Delamination

The slurry obtained by intercalation was charged into a 50 mL centrifuge tube, centrifuged for 5 minutes under the condition of 3,500 G using a centrifuge, and then the supernatant was recovered to obtain a clay containing two-dimensional particles (single-layer MXene particles). Further, an operation of adding 35 mL of water, then stirring the mixture with a shaker for 15 minutes, centrifuging the mixture for 5 minutes at 3,500 G, and recovering the supernatant as a single-layer MXene particle-containing liquid was repeated four times to obtain a single-layer MXene particle-containing supernatant. Further, this supernatant was centrifuged under the conditions of 4,300 G and 2 hours using a centrifuge, and then the supernatant was discarded to obtain a clay containing two-dimensional particles (single-layer MXene particles).

### Comparative Example 4

After the precursor (MAX) was prepared in the same manner as in Example 1, the following step (2) was performed, the washing step was performed, and then the following step (5) was further performed to produce a clay containing two-dimensional particles (single-layer MXene particles).
(1) Preparation of precursor (MAX): Same as in Example 1
(2) Etching of precursor and intercalation

Using the Ti₃AlC₂ particles (powder) prepared by step of (1), etching was performed under the following etching conditions to obtain a solid-liquid mixture (slurry) containing a solid component derived from the Ti₃AlC₂ powder.

### (Conditions of Etching and Intercalation)

Precursor: Ti₃AlC₂ (sieving with a mesh size of 45 m)
Etching solution composition: LiF 3 g
   HCl(9M) 30 mL
Amount of precursor input: 3.0 g
Etching container: 100 mL bottle made of polypropylene (Aiboy)
Etching temperature: 35° C.
Etching time: 24 h
Stirrer rotation speed: 400 rpm
(3) Washing: Same as in Example 1
(5) Delamination

The slurry obtained by intercalation was charged into a 50 mL centrifuge tube, centrifuged for 5 minutes under the condition of 3,500 G using a centrifuge, and then the supernatant was recovered to obtain a clay containing two-dimensional particles (single-layer MXene particles). Further, an operation of adding 35 mL of water, then stirring the mixture with a shaker for 15 minutes, centrifuging the mixture for 5 minutes at 3,500 G, and recovering the supernatant as a single-layer MXene particle-containing liquid was repeated four times to obtain a single-layer MXene particle-containing supernatant. Further, this supernatant was centrifuged under the conditions of 4,300 G and 2 hours using a centrifuge, and then the supernatant was discarded to obtain a clay containing two-dimensional particles (single-layer MXene particles).

### Comparative Examples 5 and 6

The preparation of the precursor (MAX), the etching step, the washing step, and the delamination step were performed in the same manner as in Example 1, and then the following step (5) was performed to produce a clay containing two-dimensional particles (single-layer MXene particles).
(1) Preparation of precursor (MAX): Same as in Examples 1 to 8
(2) Etching of precursor: Same as in Examples 1 to 8
(3) Washing: Same as in Example 1
(4) Intercalation: Same as in Examples 1 to 8
(5) Delamination

The slurry obtained by intercalation was charged into a 50 mL centrifuge tube, centrifuged for 5 minutes under the condition of 3,500 G using a centrifuge, and then the supernatant was recovered to obtain a clay containing two-dimensional particles (single-layer MXene particles). Further, an operation of adding 35 mL of water, then stirring the mixture with a shaker for 15 minutes, centrifuging the mixture for 5 minutes at 3,500 G, and recovering the supernatant as a single-layer MXene particle-containing liquid was repeated four times to obtain a single-layer MXene particle-containing supernatant. Further, this supernatant was centrifuged under the conditions of 4,300 G and 2 hours using a centrifuge, and then the supernatant was discarded to obtain a clay containing two-dimensional particles (single-layer MXene particles).

### (Method for Measuring Phosphorus Atom Content)

The clays containing the two-dimensional particles (single-layer MXene particles) obtained in Examples 1 to 13 and Comparative Examples 1 to 6 were subjected to suction filtration. After the filtration, vacuum drying was performed at 80° C. for 24 hours to produce a conductive film including the two-dimensional particles. As a filter for suction filtration, a membrane filter (Durapore, manufactured by Merck KGaA, pore size 0.45 m) was used. The supernatant contained 0.05 g of solid content of the two-dimensional particles and 40 mL of pure water.

The obtained conductive film including the two-dimensional particles was measured by X-ray photoelectron spectroscopy (XPS), and the content of phosphorus atoms contained in the two-dimensional particle was measured. Quantum2000 manufactured by ULVAC-PHI, Inc. was used for the XPS measurement.

The content of phosphorus atoms contained in the two-dimensional particles was 0.20% by mass in Example 1, 0.25% by mass in Example 2, 0.32% by mass in Example 3, 0.34% by mass in Example 4, 0.14% by mass in Comparative Example 1, 0.18% by mass in Comparative Example 2, 0.20% by mass in Comparative Example 5, and 0.34% by mass in Comparative Example 6.

### (Method for Measuring Li Atom Content)

The solution obtained by dissolving the two-dimensional particles (single-layer MXene particles) obtained in Examples 1 to 13 and Comparative Examples 1 to 6 by an alkali melting method was measured by inductively coupled plasma atomic emission spectrometry (ICP-AES), and metal cations contained in the two-dimensional particles were detected. For the ICP-AES measurement, iCAP7400 manufactured by Thermo Fisher Scientific Inc. was used.

The content of Li atoms contained in the two-dimensional particles was 0.30% by mass in Example 1.

TABLE 1

| | | | Examples | | | | | | | | | | | | |
|---|---|---|---|---|---|---|---|---|---|---|---|---|---|---|---|
| | | | 1 | 2 | 3 | 4 | 5 | 6 | 7 | 8 | 9 | 10 | 11 | 12 | 13 |
| Etching | HF concentration | mol/L | 2.8 | 2.8 | 2.8 | 2.8 | 6.9 | 6.9 | 6.9 | 13.9 | 6.9 | 6.9 | 6.9 | 6.9 | 6.9 |
| conditions | H₃PO₄ concentration | mol/L | 5.5 | 7.4 | 11 | 13.2 | 3.7 | 7.4 | 11 | 7.4 | 7.4 | 7.4 | 7.4 | 7.4 | 7.4 |

Comparative Examples

| | | | 1 | 2 | 5 | 6 |
|---|---|---|---|---|---|---|
| Etching | HF concentration | mol/L | 2.8 | 2.8 | 2.8 | 2.8 |
| conditions | H₃PO₄ concentration | mol/L | 1.9 | 3.7 | 5.5 | 13.2 |

### (⁷Li NMR Measurement Method: Quantification of First Component and Second Component)

In a glove box in an Ar atmosphere (dew point lower than −60° C.), two-dimensional particles (single-layer MXene particles) and the dried Al₂O₃ powder were mixed at a mass ratio of 1:9, and pulverized in an agate mortar to obtain a mixed powder. In the glove box, the mixed powder was filled in a solid NMR zirconia sample tube having an outer diameter of 4 mm, and was capped with a cap made of Kel-F to prepare an NMR measurement sample. The total amount of the sample consisting of two-dimensional particles (single-layer MXene particles) and the Al₂O₃ powder was 200 mg.

As a ⁷Li NMR apparatus (spectrometer), AVANCE III 400(Magnetic field strength: 9.4 T, resonance frequency of ⁷Li nucleus: 155.455 MHz) manufactured by Bruker was used. As the probe, PH MAS 400S1 BL4 N-P/H VTN manufactured by Bruker was used.

⁷Li NMR measurement was performed under the following conditions to obtain a one-dimensional ⁷Li NMR spectrum.
Measurement method: Magic angle rotation+single pulse method
Magic angle rotation speed: 15 kHz
Pulse intensity: 28 to 56 kHz (output fixed at 100 W)
Pulse flip angle: 90°
Integration delay time: 4 seconds
Number of integrations: 1,024 times

The obtained ⁷Li NMR spectrum was subjected to regression with a Lorentz curve of two components to determine the chemical shift value and the relative area of each peak. The reference material was Li in a 1 mol/L LiCl aqueous solution. For the regression calculation of Li and the calculation of the chemical shift value and the relative area, a spectral fitting function attached to NMR console software manufactured by Bruker was used. Peaks attributed to each of the first component and the second component were identified from the chemical shift value, and the proportion of the first component (on an atomic basis) was calculated as S₁/(S₁+S₂) from the relative area S₁ of the peak attributed to the first component and the relative area S₂ of the peak attributed to the second component. The results are shown in Table 2.

TABLE 2

| | | | Examples | | | | | | |
|---|---|---|---|---|---|---|---|---|---|
| | | | 4 | 5 | 9 | 10 | 11 | 12 | 13 |
| First | Relative area S₁ | | 0.17 | 0.37 | 0.7 | 0.61 | 0.44 | 0.45 | 0.64 |
| component | Chemical shift | ppm | 0.23 | −0.1 | 0.5 | 0.5 | 0 | −0.1 | 0.3 |
| | Half-value width | ppm | 1.75 | 2.38 | 1.90 | 1.97 | 2.39 | 2.41 | 1.80 |
| Second | Relative area S₂ | | 0.83 | 0.63 | 0.30 | 0.39 | 0.56 | 0.55 | 0.36 |
| component | Chemical shift | ppm | 1.08 | 1.3 | 1.4 | 1.4 | 1.3 | 1.3 | 1.4 |
| | Half-value width | ppm | 0.34 | 0.50 | 0.50 | 0.45 | 0.55 | 0.50 | 0.52 |

| | | | | | | | |
|---|---|---|---|---|---|---|---|
| First component/ | 0.17 | 0.37 | 0.7 | 0.61 | 0.44 | 0.45 | 0.64 |
| (first component + second component) | | | | | | | |

Comparative Examples

| | | | 3 | 4 | 5 | 6 |
|---|---|---|---|---|---|---|
| First | Relative area S₁ | | 0.8 | 0.89 | — | — |
| component | Chemical shift | ppm | −0.1 | −0.7 | — | — |
| | Half-value width | ppm | 3.26 | 2.97 | — | — |
| Second | Relative area S₂ | | 0.20 | 0.11 | 1.00 | 1.00 |
| component | Chemical shift | ppm | 1.2 | 1.3 | 0.77 | 0.99 |
| | Half-value width | ppm | 0.55 | 0.59 | 0.78 | 0.40 |

| | | | | |
|---|---|---|---|---|
| First component/ | 0.8 | 0.89 | 0 | 0 |
| (first component + second component) | | | | |

In the two-dimensional particles of Examples, the proportion of the first component in the total of the first component and the second component was in the range of not less than 1700 by atom and not more than 70% by atom. In particular, in Examples 4 and 5, the phosphoric acid aqueous solution was used at the time of delamination, whereas in Examples 9 to 13, only pure water was used without using the phosphoric acid aqueous solution at the time of delamination. It is considered that in Examples 4 and 5 and Examples 9 to 13, the etching conditions are different, and thus the state of the surface group of the MXene layer is different, and in Examples 9 to 13, two-dimensional particles in which the proportion of the first component in the total of the first component and the second component is not less than 170% by atom and not more than 70% by atom were obtained by delamination with only pure water. On the other hand, in the two-dimensional particles of Comparative Examples 3 and 4, the proportion of the first component in the total of the first component and the second component exceeded 70% by atom, and in the two-dimensional particles of Comparative Examples 5 and 6, the first component was not detected.

### (⁷Li NMR Measurement Method: Measurement of T2 Relaxation Time)

For the two-dimensional particles of Example 5 and Comparative Examples 2 to 4, NMR measurement samples were prepared in the same manner as in the quantification of the first component and the second component, and the same ⁷Li NMR apparatus as in the quantification of the first component and the second component was used.

⁷Li NMR measurement was performed under the following conditions to obtain a one-dimensional ⁷Li NMR spectrum.
Measurement method: Magic angle rotation+CPMG method
Magic angle rotation speed: 12.5 kHz
Pulse intensity: 28 to 56 kHz (output fixed at 100 W)
Echo time: 160 s
Number of echoes: 48 times
Integration delay time: 4 seconds
Number of integrations: 1,024 times

The relative area of each echo was plotted with respect to the refocusing time with respect to the actual component after applying the phase correction to the obtained time domain data. Relative areas of the first component and the second component obtained in the above quantitative measurement were regressed on this echo attenuation profile by a sum of exponential functions fixed as a coefficient ratio, and a time constant (T2 relaxation time) of each component was determined.

The T2 relaxation time of the first component in the two-dimensional particle of Example 5 was 0.47 ms, and the T2 relaxation time of the second component was 1.7 ms. The T2 relaxation time of the first component in the two-dimensional particle of Comparative Example 2 was 0.36 ms, and the T2 relaxation time of the second component was 2 ms. The T2 relaxation time of the first component in the two-dimensional particle of Comparative Example 3 was 0.56 ms, and the T2 relaxation time of the second component was 1.5 ms. The T2 relaxation time of the first component in the two-dimensional particle of Comparative Example 4 was 0.44 ms, and the T2 relaxation time of the second component was 1.2 ms. In these two-dimensional particles, the T2 relaxation time of the first component is shorter than the T2 relaxation time of the first component, and it is considered that the first component interacts more strongly with the substance.

### (First Method for Producing Conductive Composite Film)

To 50 g of a dispersion of two-dimensional particles of Example 5 (concentration of two-dimensional particles (MXene solid content): 6.4% by mass), 52.750 g of a solution obtained by diluting a polyurethane solution (manufactured by Dainichiseika Color & Chemicals Mfg. Co., Ltd., nonvolatile content concentration: 35% by mass) 100 times with pure water was added to form a composite. Thereafter, the composite was stirred for 15 minutes using an automatic shaker (SK 550 manufactured by F&FM). A polyimide film (Kapton film manufactured by DU PONT-TORAY CO., LTD.) was prepared, the surface of the polyimide film was hydrophilized by oxygen plasma treatment (PC-1000 manufactured by SAMCO Inc.), and then the above-mentioned composite was spray-coated on the film 30 times. It is to be noted that each spray application was dried with a dryer for 2 minutes. As a spray nozzle, a nozzle manufactured by ATOMAX was used.

After the application, the film was dried in a normal pressure oven at 80° C. for 2 hours, and then dried in a vacuum oven at 150° C. overnight to obtain a spray film. The film thickness of the obtained composite spray film was 4.4 m, and the initial conductivity measured by a conductivity measurement method described later was 17,668 S/cm. In addition, after a moisture resistance test was performed at room temperature and a humidity of 99% for 14 days, the conductivity measured in the same manner was 8,127 S/cm, and the rate of change from the initial conductivity was 46%.

To 25.221 g of a dispersion of two-dimensional particles of Comparative Example 3 (concentration of two-dimensional particles (MXene solid content): 3.25% by mass), 14.779 g of a solution obtained by diluting a polyurethane solution (manufactured by Dainichiseika Color & Chemicals Mfg. Co., Ltd., nonvolatile content concentration: 35% by mass) 100 times with pure water was added to form a composite. Thereafter, the composite was stirred for 15 minutes using an automatic shaker (SK 550 manufactured by F&FM). A polyimide film (Kapton film manufactured by DU PONT-TORAY CO., LTD.) was prepared, the surface of the polyimide film was hydrophilized by oxygen plasma treatment (PC-1000 manufactured by SAMCO Inc.), and then the above-mentioned composite was spray-coated on the film 30 times. It is to be noted that each spray application was dried with a dryer for 2 minutes. As a spray nozzle, a nozzle manufactured by ATOMAX was used.

After the application, the film was dried in a normal pressure oven at 80° C. for 2 hours, and then dried in a vacuum oven at 150° C. overnight to obtain a spray film. The film thickness of the obtained composite spray film was 3.2 m, and the initial conductivity measured by a conductivity measurement method described later was 10,269 S/cm, which was lower than the case of using the two-dimensional particles of Example 5. In addition, after a moisture resistance test was performed at room temperature and a humidity of 99% for 14 days, the conductivity measured in the same manner was 3,081 S/cm, and the rate of change from the initial conductivity was 30%.

From the above, it was confirmed that the conductive composite film containing the two-dimensional particles of Example 5 had high initial conductivity and good moisture resistance. On the other hand, in the two-dimensional particles of Comparative Example 3, the proportion of the first component in the total of the first component and the second component exceeded 70% by atom, and the initial conductivity and the moisture resistance were not sufficiently satisfactory.

### (First Method for Producing Conductive Film)

15 mL of pure water was added to 0.5 g of clays containing the two-dimensional particles (single-layer MXene particles) obtained in Examples 4, 6, and 7 and Comparative Examples 3 and 4, and then suction filtration was performed using a Nutsche. After the filtration, vacuum drying was performed at 80° C. for 24 hours to produce a conductive film including the two-dimensional particles. As a filter for suction filtration, a membrane filter (pore size 0.22 m) was used.

The conductive film containing the two-dimensional particles obtained in Example 4 had a film density of 3.6 g/cm³ and the conductivity of 14,000 S/cm. The conductive film containing the two-dimensional particles obtained in Example 6 had a film density of 3.7 g/cm³ and the conductivity of 15,700 S/cm, and a conductivity change rate of 95%. The conductive film containing the two-dimensional particles obtained in Example 7 had a film density of 3.2 g/cm³ and the conductivity of 13,600 S/cm, and the conductivity change rate of 94%. The conductive film containing the two-dimensional particles obtained in Comparative Example 3 had a film density of 2 g/cm³ and the conductivity of 9,000 S/cm, and the conductivity change rate of 78%. The conductive film containing the two-dimensional particles obtained in Comparative Example 4 had a film density of 2 g/cm³ and the conductivity of 6,000 S/cm, and the conductivity change rate of 23%.

From the above, it was confirmed that the conductive film containing the two-dimensional particles obtained in Examples had high conductivity and also had good moisture resistance. On the other hand, in Comparative Examples 3 and 4, the proportion of the first component in the total of the first component and the second component exceeded 70% by atom, and the conductivity and the conductivity change rate of the obtained conductive film were not sufficiently satisfactory.

### (Second Method for Producing Conductive Film)

The clay containing the two-dimensional particles (single-layer MXene particles) obtained in Examples 1 to 13 was applied onto a polyethylene terephthalate film (LUMIRROR manufactured by Toray Industries, Inc.) so as to have a thickness of 120 m or less. Thereafter, air drying was performed to obtain a conductive film by coating. The film thickness of the obtained conductive film was 1 m.

### (Third Method for Producing Conductive Film)

4 mL of pure water was added to 0.5 g of the clays containing the two-dimensional particles (single-layer MXene particles) obtained in Examples 1 to 13. Thereafter, the film was spray-coated 1 to 30 times on a polyethylene terephthalate film (LUMIRROR manufactured by Toray Industries, Inc.) with a spray gun (air brush manufactured by TAMIYA, INC.). It is to be noted that each spray application was dried with a dryer for 2 minutes. After the application, the film was dried in a normal pressure oven at 80° C. for 2 hours, and then dried in a vacuum oven at 150° C. overnight to obtain a spray film.

The film density, the conductivity, and the conductivity change rate of the conductive film were measured by the following methods.

### (Method for Measuring Film Density)

The film was punched into a diameter of 12 mmφ with a punch, the weight was measured with an electronic balance, and the thickness was measured with a height gauge. The film density was calculated from the obtained values.

### (Method for Measuring Conductivity of Conductive Film)

The conductivity of the obtained conductive film containing two-dimensional particles was determined. For the conductivity, the resistivity (Q) and the thickness (m) were measured at three points per sample, the conductivity (S/cm) was calculated from these measured values, and the average value of three conductivities obtained by this calculation was adopted. For resistivity measurement, the surface resistance of the conductive film was measured by a four-terminal method using a simple low resistivity meter (Loresta AX MCP-T370, manufactured by Mitsubishi Chemical Analytech Co., Ltd.). A micrometer (MDH-25 MB, manufactured by Mitutoyo Corporation) was used for the thickness measurement. Then, the volume resistivity was determined from the obtained surface resistance and the thickness of the conductive film, and the conductivity was determined as E₀ by taking the reciprocal of the value.

### (Method for Measuring Conductivity Change Rate)

The conductive film was placed in a thermo-hygrostat at a relative humidity of 99% and a temperature of 25° C. After standing for 7 days, the conductivity was measured and evaluated as E. E was divided by E₀ to obtain the conductivity change rate.

### EXPLANATION OF REFERENCES

1a, 1b Layer body (MₘXₙ layer)
3a, 5a, 3b, 5b Modifier or terminal T
7a, 7b MXene layer
10, 10a, 10b MXene particles (two-dimensional particles of layered material)

1. A two-dimensional particle comprising:
one or plural layers, wherein the one or plural layers include a layer body represented by:
MₘXₙ
wherein M is at least one metal of Group 3, 4, 5, 6, or 7,
X is a carbon atom, a nitrogen atom, or a combination thereof,
n is not less than 1 and not more than 4, and
m is more than n but not more than 5, and
a modifier or terminal T existing on a surface of the layer body, wherein T is at least one selected from the group consisting of a hydroxyl group, a fluorine atom, a chlorine atom, an oxygen atom, and a hydrogen atom; and
a Li atom, wherein the Li atom includes a first component and a second component, wherein the second component has a second chemical shift measured by ⁷Li NMR that is larger than a first chemical shift of the first component, and wherein a proportion of the first component in a total of the first component and the second component is not less than 17% by atom and not more than 70% by atom.

2. The two-dimensional particle according to claim 1, wherein the first chemical shift of the first component measured by ⁷Li NMR is less than 0.6 ppm, and the second chemical shift of the second component measured by ⁷Li NMR is not less than 0.6 ppm and not more than 2.0 ppm.

3. The two-dimensional particle according to claim 1, wherein the first chemical shift of the first component measured by ⁷Li NMR is not less than −0.2 ppm and not more than 0.55 ppm, and the second chemical shift of the second component measured by ⁷Li NMR is not less than 0.7 ppm and not more than 1.7 ppm.

4. The two-dimensional particle according to claim 1, wherein the Li atom is on the layer body.

5. The two-dimensional particle according to claim 4, wherein the second component is adsorbed on the surface the layer body.

6. The two-dimensional particle according to claim 1, wherein a T2 relaxation time of the first component is shorter than a T2 relaxation time of the second component.

7. The two-dimensional particle according to claim 6, wherein the T2 relaxation time of the first component is 0.6 ms or less, and the T2 relaxation time of the second component is 1.2 ms or more.

8. The two-dimensional particle according to claim 1, wherein a content of the Li atoms in the two-dimensional particle is not less than 0.1% by mass and not more than 20% by mass.

9. The two-dimensional particle according to claim 1, further comprising a phosphorus atom.

10. The two-dimensional particle according to claim 9, wherein a content of the phosphorus atom in the two-dimensional particle is not less than 0.1% by mass and not more than 14% by mass.

11. The two-dimensional particle according to claim 9, wherein the phosphorus atom is in a form of PO₄³⁻.

12. The two-dimensional particle according to claim 1, wherein an average thickness of the two-dimensional particle is not less than 1 nm and not more than 10 nm.

13. A conductive film comprising the two-dimensional particle according to claim 1.

14. A conductive paste comprising the two-dimensional particle according to claim 1.

15. A conductive composite material comprising:
the two-dimensional particle according to claim 1; and
a resin.

16. A method for producing a two-dimensional particle of the present embodiment, the method comprising:
(a) preparing a predetermined precursor represented by:
MₘAXₙ
wherein M is at least one metal of Group 3, 4, 5, 6, or 7,
X is a carbon atom, a nitrogen atom, or a combination thereof,
A is at least one metal of Group 12, 13, 14, 15, or 16,
n is not less than 1 and not more than 4, and
m is more than n but not more than 5;
(b) removing at least a part of A atoms from the precursor by using an etching solution to obtain an etched product, the etching solution containing a phosphorus atom;
(c) washing the etched product with water to obtain a water-washed product;
(d) mixing the water-washed product with a metal-containing compound to obtain an intercalated product, the metal-containing compound containing at least a Li atom; and
(e) performing a delamination treatment to obtain a two-dimensional particle, the delamination treatment including a step of stirring the intercalated product so as to delaminate the intercalated product and obtain a two-dimensional particle.
